(19) United States
(12) Patent Application Publication
(10) Pub. No.: US 2004/0253005 A1
(43) Pub. Date: Dec. 16, 2004

(54) Sheet body holding device

(75) Inventor: Takashi Fukui, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/823,637

(22) Filed: Apr. 14, 2004

(30) Foreign Application Priority Data
Apr. 15, 2003 (JP) 2003-109749

(51) Int. Cl. G03G 15/00; G03G 15/04; G03G 15/22

(52) U.S. Cl. 399/1

(57) ABSTRACT

A sheet body holding device for holding a sheet body on an outer periphery of a rotary drum, including: a spindle that rotatably supports the sheet body holding device on the outer periphery of the rotary drum; and one end urged toward the rotary drum, and pressing an end of the sheet body against the outer periphery of the rotary drum, thereby holding the end of the sheet body on the outer periphery of the rotary drum. The spindle is arranged at a position at which a relationship of F1<(F2×μ) is satisfied, where F1 is a component force, in a tangential direction of the rotary drum, F2 is a component force of the pressing force in a direction of a center axis of the rotary drum, and μ is a coefficient of friction between the sheet body and the outer periphery of the rotary drum.

### CROSS-REFERENCE TO THE RELATED APPLICATION

This application claims priority under 35 USC 119 from Japanese Patent Application No. 2003-109749, the disclosure of which is incorporated by reference herein.

### BACKGROUND OF THE INVENTION

1. Field of the Invention

The present invention relates to a sheet body holding device for holding a sheet body on an outer periphery of a rotational member.

2. Description of the Related Art

A technology (e.g., a printing plate exposure apparatus) for utilizing a sheet-like printing plate (e.g., a PS plate, a thermal plate, or a photopolymer plate) in which a recording layer (e.g., a photosensitive layer) is provided on a support body, and directly recording an image on the photosensitive layer using a laser beam of the like, is being developed. In such technology, an image can be recorded on the printing plate rapidly.

Among these printing plate exposure apparatuses, for example, there is an exposure apparatus which performs exposure processing by using a recording head disposed near a cylindrical rotary drum while the printing plate is fixedly wound around the rotary drum and the rotary drum is being rotated at a high speed (see, for example, Japanese Patent Application Laid-Open (JP-A) No. 2000-112142).

In the printing plate exposure apparatus, a plate-like leading end chuck is rotatably supported on the outer periphery of the rotary drum. An elastic force is applied to a front end of the leading end chuck in a direction to move away from the rotary drum. A release lever (leading end chuck opening and closing unit) is provided adjacent to the rotary drum. When the e release lever presses the front end of the leading end chuck against the outer periphery of the rotary drum, a rear end of the leading end chuck is distanced from the outer periphery of the rotary drum. A leading end of the printing plate is conveyed between the rear end of the leading end chuck and the outer periphery of the rotary drum, and is abutted on a positioning member, thereby positioning the printing plate.

When the positioning of the leading end of the printing plate is finished, the pressing of the release lever on the front end of the leading end chuck is released. As a result, the rear end of the leading end chuck presses the leading end of the printing plate against the rotary drum by the elastic force, and the leading end of the printing plate is held on the outer periphery of the rotary drum. Further, by rotating the rotary drum, the printing plate is wound around the outer periphery of the rotary drum, and by attaching a rear-end chuck onto the outer periphery of the rotary drum, the rear-end chuck holds a rear end of the printing plate on the outer periphery of the rotary drum.

While the rotary drum is rotated at high speed, a pressing force that is generated on the rear end of the leading end chuck by a centrifugal force acts on the printing plate which is held by the rear end of the leading end chuck.

When a rotation fulcrum of the leading end chuck is located on a rotary drum side relative to a tangent of the rotary drum at a position at which the rear end of the leading end chuck holds the printing plate, a component force of the pressing force that acts on the rear end of the leading end chuck acts in a direction to generate slack in the printing plate. As a result, slack is generated in the printing plate fixedly held on the rotary drum, thereby disadvantageously causing a focal shift of the image recorded on the printing plate. Further, since the leading end of the printing plate moves in a circumferential direction of the rotary drum, a position of the image recorded on the printing plate is deviated from a reference position set to the printing plate in advance. As a result, a clear image cannot be often acquired.

On the other hand, when the rotation fulcrum of the leading end chuck is located on a side opposite to the rotary drum side relative to the tangent of the rotary drum at the position at which the rear end of the leading end chuck holds the printing plate, the component force of the pressing force that acts on the rear end of the leading end chuck by the centrifugal force acts in a direction of pressing the printing plate against the positioning member. As a result, the printing plate floats from the rotary drum around the positioning member, thereby disadvantageously causing the focal shift of the image recorded on the printing plate.

### SUMMARY OF THE INVENTION

In view of the aforementioned, an object of the invention to provide a sheet body holding device capable of preventing a sheet body from being moved in a circumferential direction of a rotary drum and preventing the sheet body from being floated from an outer periphery of the rotary drum.

A first aspect of the present invention is to provide a sheet body holding device for holding a sheet body on an outer periphery of a rotary drum, comprising: a spindle that rotatably supports the sheet body holding device on the outer periphery of the rotary drum, around which the sheet body is wound; and one end urged toward the rotary drum, and pressing an end of the sheet body against the outer periphery of the rotary drum, thereby holding the end of the sheet body on the outer periphery of the rotary drum, wherein the spindle is arranged at a position at which a relationship of F1<(F2×μ) is satisfied, where F1 is a component force, in a tangential direction of the rotary drum, of a pressing force of the one end for pressing the sheet body during rotation of the rotary drum, F2 is a component force of the pressing force in a direction of a center axis of the rotary drum, and μ is a coefficient of friction between the sheet body and the outer periphery of the rotary drum.

In the sheet body holding device, one end always urged toward the rotary drum presses the end portion of the sheet body against the outer periphery of the rotary drum and thereby holds the sheet body on the outer periphery of the rotary drum. While the sheet body is wound around the rotary drum, the rotary drum is rotated.

The spindle is arranged at a position at which a relationship of F1<(F2×μ) is satisfied, where F1 is a component force, in a tangential direction of the rotary drum, of a pressing force of the one end for pressing the sheet body during rotation of the rotary drum, F2 is the component force of the pressing force in a direction of a center axis of the rotary drum, and μ is a coefficient of friction between the sheet body and the outer periphery of the rotary drum.

That is, the spindle is arranged at a position at which the force (F1) for moving the sheet body in the circumferential direction of the rotary drum is higher than a friction force (F2×μ) between the sheet body and the outer periphery of the rotary drum.

In this way, the sheet body is prevented from being moved in the circumferential direction of the rotary drum, and floating of the sheet body away from the outer periphery of rotary drum, which occurs due to the sheet body being moved in the circumferential direction of the rotary drum, is prevented.

Thus, the sheet body holding device according to the first aspect of the invention prevents the sheet body from being moved in the circumferential direction of the rotary drum. In addition, the sheet body holding device can prevent the sheet body from being floated from the outer periphery of rotary drum.

In the first aspect of the invention, a center of the spindle is located on a tangent of the rotary drum intersecting a pressing position at which the sheet body is pressed against the rotary drum.

In the sheet body holding device mentioned above, the spindle is located on the tangent of the rotary drum at the pressing position P at which the sheet body is pressed. Therefore, when the rotary drum is rotated, the pressing force of the one end for pressing the sheet body acts substantially in the same direction as a center axis direction of the rotary drum (note that the direction is slightly deviated from the center axis direction by as much as a thickness of the sheet body). In other words, the component force F1 of the pressing force in the tangential direction of the rotary drum (the force for moving the sheet body in the circumferential direction of the rotary drum) acts on the sheet body only slightly.

In this way, the sheet body is prevented from being moved in the circumferential direction of the rotary drum, and floating of the sheet body away from the outer periphery of rotary drum, which occurs due to the sheet body being moved in the circumferential direction of the rotary drum, is prevented.

A second aspect of the present invention is to provide a sheet body holding device for holding a sheet body on an outer periphery of a rotary drum, comprising: a spindle that rotatably supports the sheet body holding device on the outer periphery of the rotary drum, around which the sheet body is wound; and one end urged toward the rotary drum, and pressing an end of the sheet body against the outer periphery of the rotary drum, thereby holding the end of the sheet body on the outer periphery of the rotary drum, wherein an angle θ is formed between a line that connects a pressing position at which the one end presses the sheet body against the rotary drum and a center of the spindle and a tangent of the rotary drum intersecting the pressing position, and the spindle is located at a position at which the angle θ is acute.

A third aspect of the present invention is to provide a method for manufacturing a sheet body holding device that holds a sheet body on an outer periphery of a rotary drum, comprising: forming a spindle that rotatably supports the sheet body holding device on the outer periphery of the rotary drum, around which the sheet body is wound; and forming one end which is urged toward the rotary drum and presses an end of the sheet body against the outer periphery of the rotary drum, thereby holding the end of the sheet body on the outer periphery of the rotary drum, wherein an angle θ is formed between a line that connects a pressing position at which the one end presses the sheet body against the rotary drum and a center of the spindle and a tangent of the rotary drum intersecting the pressing position, and the spindle is located at a position at which the angle θ is acute.

A fourth aspect of the present invention is to provide a printing plate exposure apparatus comprising a sheet body holding device including: a spindle rotatably supporting the sheet body holding device on an outer periphery of a rotary drum around which the sheet body is wound; and one end urged toward the rotary drum, and pressing an end of the sheet body against the outer periphery of the rotary drum, thereby holding the end of the sheet body on the outer periphery of the rotary drum, wherein an angle θ is formed between a line that connects a pressing position at which the one end presses the sheet body against the rotary drum and a center of the spindle and a tangent of the rotary drum intersecting the pressing position, and the spindle is located at a position at which the angle θ is acute.

### BRIEF DESCRIPTION OF THE DRAWINGS

FIG. 1 is a side view of a sheet body holding device according to an embodiment of the present invention.

FIG. 2A is a side view which depicts an acting direction of a sheet body pressing force in the sheet body holding device according to the embodiment of the invention.

FIG. 2B is a side view which depicts an acting direction of the sheet body pressing force in a conventional sheet body holding device.

FIG. 3 is a perspective view which depicts the structure of the sheet body holding device according to the embodiment of the invention.

FIG. 4 is a perspective view which depicts the structure of main portions of an exposure section in the sheet body holding device according to the embodiment of the invention.

FIG. 5 is a perspective side view which depicts the structure of an automatic printing plate exposure apparatus according to the embodiment of the invention.

### DETAILED DESCRIPTION OF THE INVENTION

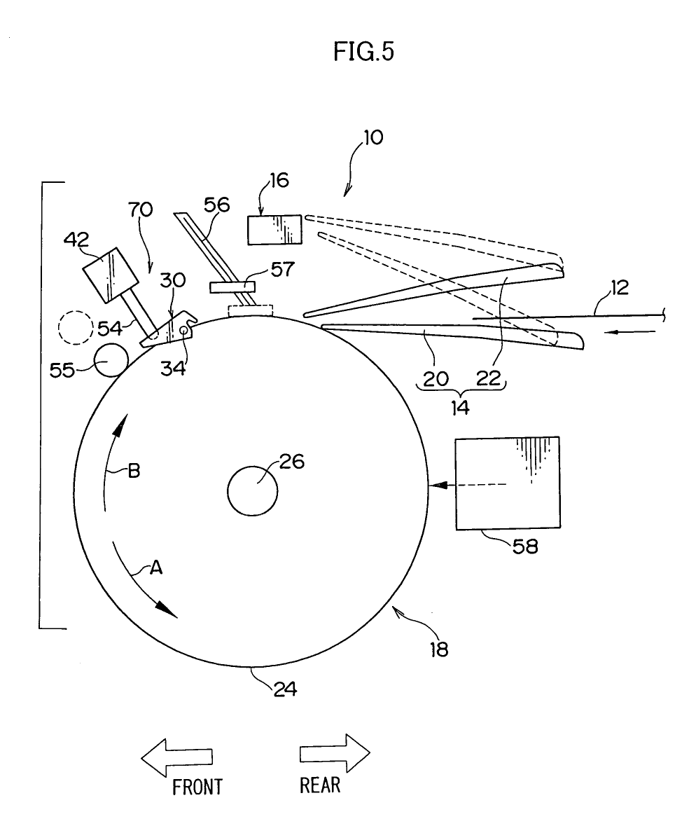

FIG. 5 shows a side view of an automatic printing plate exposure apparatus 10 according to an embodiment to which a sheet body holding device 70 according to the present invention is applied.

The automatic printing plate exposure apparatus 10 according to the embodiment exposes (records) an image on an image formation layer (e.g., a photosensitive layer, a thermosensitive layer, or the like) on a support body of a printing plate 12, serving as a sheet body, such as a photopolymer plate or a thermal plate. The automatic printing plate exposure apparatus 10 is divided into a conveyance guide unit 14, a punch section 16, and an exposure section 18. The punch section 16 and the exposure section 18 are arranged in front of the conveyance guide unit 14. The exposure section 18 is arranged below the punch section 16.

The conveyance guide unit 14 includes a plate feed guide 20 having a substantially rectangular plane shape and a plate discharge guide 22 having a substantially rectangular plane shape. Relative positions of the plate feed guide 20 and the plate discharge guide 22 form an inverted V shape in a side view. The conveyance guide unit 14 is constructed to rotate about the right end side of FIG. 5 as a rotational center at a predetermined angle. For this rotation, the plate feed guide 20 and the plate discharge guide 22 can be selectively set to correspond to the punch section 16 or the exposure section 18. Further, the printing plate 12 is provided onto the plate feed guide 20.

When the conveyance guide unit 14 is rotated and the plate feed guide 20 correspond (oppose) to the punch section 16, a leading end of the printing plate 12 on the plate feed guide 20 is transported into the punch section 16. As a result, a predetermined number of punch holes (not shown) such as circular holes or elongated holes are bored through the leading end of the printing plate 12 by the punch section 16. After the processing to the printing plate 12 by the punch section 16 is finished, the printing plate 12 is returned onto the plate feed guide 20.

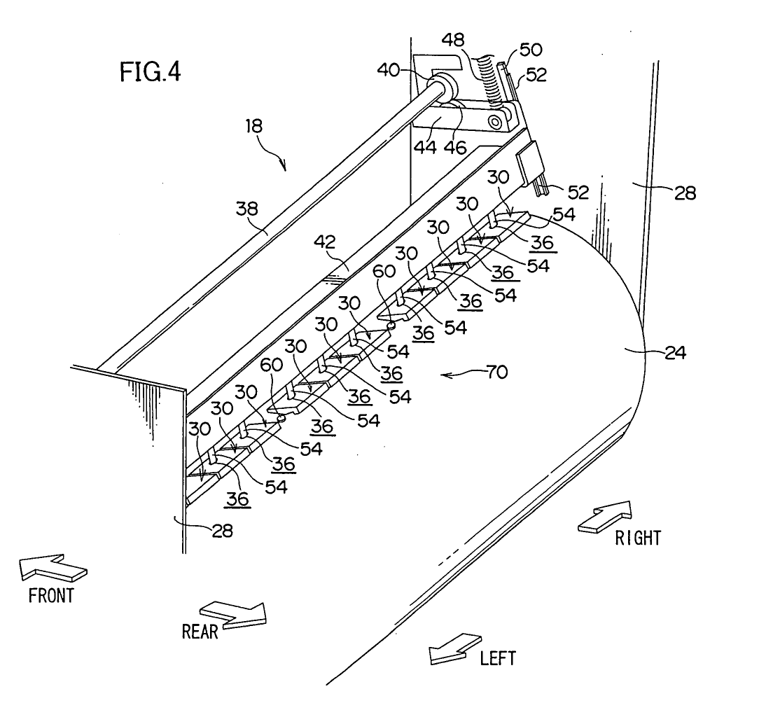

The exposure section 18 includes a rotary drum 24. The rotary drum 24 has a cylindrical shape and includes a central shaft 26. The central shaft 26 is supported by a pair of support plates 28 opposed each other (see FIG. 4), whereby the rotary drum 24 is rotatable in an arrow A direction and an arrow B direction. After the printing plate 12 is returned from the punch section 16 onto the plate feed guide 20, the plate conveyance guide unit 14 is rotated to make the plate feed guide 20 correspond to the exposure section 18 (i.e., correspond to a tangential direction of the rotary drum 24), whereby the leading end of the printing plate 12 is transported onto the outer periphery of the rotary drum 24.

A predetermined number of (eleven in the present embodiment) substantially plate-like leading end chucks 30 each serving as a sheet body holding device 70 are provided on the outer periphery of the rotary drum 24 at a position at which the leading end of the printing plate 12 is transported. The predetermined number of leading end chucks 30 are disposed along a lateral direction of the rotary drum 24 (i.e., an axial direction of the rotary drum 24).

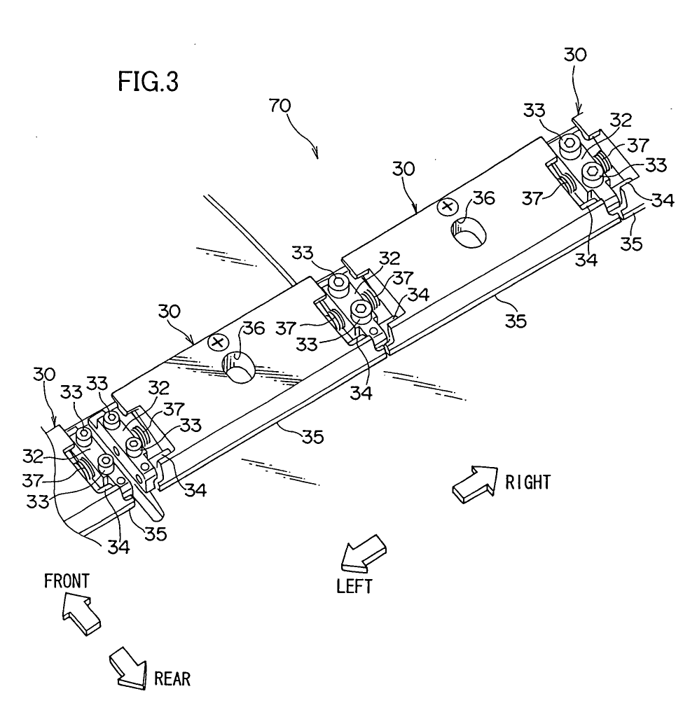

As shown in FIG. 3, support members 32 are disposed on both lateral direction sides of the leading end chuck 30, respectively. Each support member 32 is fixed onto the outer periphery of the rotary drum 24 by bolts 33. A cylindrical spindle 34 which is a component of the sheet body holding device 70 is fixed to a rear side portion of each leading end chuck 30. By allowing the spindle 34 to be supported by each support member 32, each leading end chuck 30 is supported on the outer periphery of the rotary drum 24 so as to be pivotally rotatable about the spindle 34. Further, a press concave portion 36 which is a circular hole is formed on a surface of the front portion of the leading end chuck 30, which is on the opposite side of the leading end chuck 30 from the rotary drum 24, i.e., on a surface of the leading end chuck 30 which does not face the rotary drum 24.

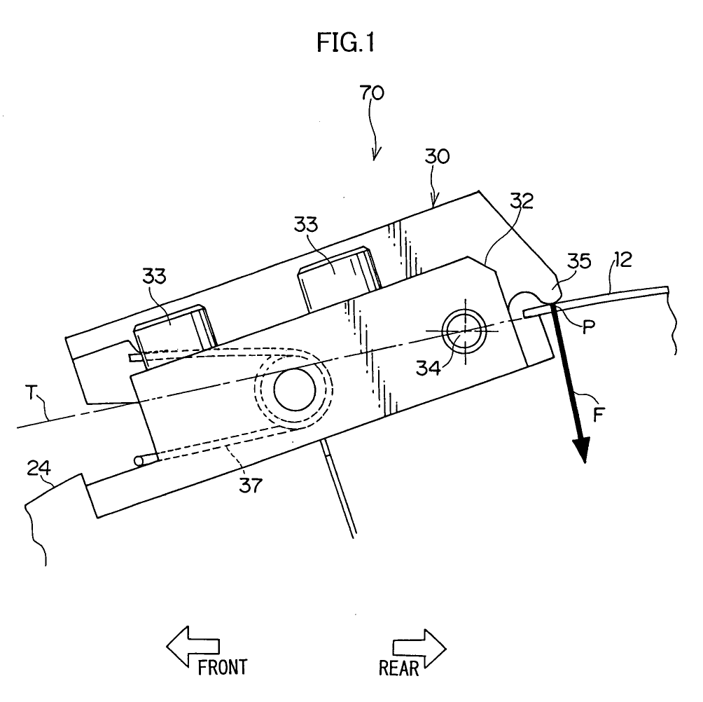

A nipping portion 35 protruding toward the rotary drum 24 is formed on a rear end of the leading end chuck 30 along the entire length of the leading end chuck 30 in the lateral direction. As shown in FIG. 1, a tip end of the nipping portion 35 is formed in an arc shape. By pivotally rotating the leading end chuck 30 about the spindle 34, the nipping portion 35 can be moved so as to contact or separate from the rotary drum 24.

Further, a torsion coil spring 37 is extended between each support member 32 and each leading end chuck 30. A urging force of the torsion coil spring 37 urges a front side of the leading end chuck 30 in a direction away from the outer periphery of the rotary drum 24. Thus, the nipping portion 35 of the leading end chuck 30 is always urged toward the rotary drum 24.

The press concave portion 36 of the leading end chuck 30 is pressed toward the rotary drum 24 by the release pin 54 fixed to an elevation member 42, which will be described later, whereby the nipping portion 35 moves to be distanced from the outer periphery of the rotary drum 24. While the nipping portion 35 is distanced from the rotary drum 24, the leading end of the printing plate 12 is transported from the plate feed guide 20 to the portion between the nipping portion 35 and the outer periphery of the rotary drum 24. When the pressing of the concave portion 36 by the release pin 54 is released, the nipping portion 35 presses the printing plate 12 against the outer periphery of the rotary drum 24 by a urging force of a torsion coil spring 37, whereby the leading end of the printing plate 12 is held on the outer periphery of the rotary drum 24.

When the rotary drum 24 is stationary, only the direct pressing force of the nipping portion 35 of the leading end chuck 30 for pressing the printing plate 12, which force is generated by the urging force of the torsion coil spring 37, acts on the printing plate 12. When the rotary drum 24 is rotated, a resultant force (hereinafter, “pressing force F”) of the direct pressing force of the nipping portion 35 of the leading end chuck 30 generated by the urging force of the torsion coil spring 37 and a force applied to the nipping portion 35 by the centrifugal force acts on the printing plate 12 acts on the printing plate 12.

As shown in FIG. 1, a center of the spindle 34 is located on a tangent T of the rotary drum 24 at a position (hereinafter, “pressing position P”) at which the nipping portion 35 of the leading end chuck 30 presses and holds the leading end of the printing plate 12. Due to this, when the rotary drum 24 is rotated, the pressing force F acting on the printing plate 12 from the nipping portion 35 of the leading end chuck 30 acts substantially in the same direction as a center axis direction of the rotary drum 24 (note that the direction is slightly shifted from the center axis direction by as much as a thickness of the printing plate 12).

The spindle 34 is arranged at a position at which the following relationship is satisfied:

F1<(F2×μ) (1)

In Expression (1), F1 denotes the component force of the pressing force F in a direction of the tangent T of the rotary drum 24, F2 denotes the component force of the pressing force F in a direction of the center axis of the rotary drum 24, and μ denotes a coefficient of friction between a back surface of the printing plate 12 (a surface in contact with the rotary drum 24) and the outer periphery of the rotary drum 24.

That is, when an angle of a line that connects the rotational center of the leading end chuck 30 (the center of the spindle 34) to the “pressing position P” of the leading end chuck 30, with respect to the tangent T of the rotary drum 24 at the “pressing position P” is θ, the following equations are established:

F1=F×sin θ,

and

F2=F×cos θ

When the equations are assigned to Expression (1), the following expression is given:

F×sin θ<(F×cos θ×μ)

Therefore, Expression (1) is replaced by the following equation:

tan θ<μ (2)

Expression (1) is equivalent to Expression (2), and the spindle 34 is arranged at the position at which Expression (2) is satisfied.

In the present embodiment, the coefficient of friction between the rear surface of the printing plate 12 and the outer periphery of the rotary drum 24 is set at, for example, 0.27 (note that the coefficient of friction is normally set at, for example, about 0.3). In the embodiment, the center of the spindle 34 (i.e., the rotation center of the leading end chuck 30) may be located in a range in which the angle θ is acute, e.g., a range of −15°<θ<15°.

In the embodiment, the spindle 34 is located at the “pressing plate P” on the tangent T of the rotary drum 24.

Therefore, the angle θ is substantially set at 0 degree (plus an angle by as much as the thickness of the printing plate 12), so that Expression (2) is satisfied. Accordingly, in the sheet body holding device 70 according to the embodiment, the spindle 34 is located at the position at which the relationship of F1<(F2×μ) is satisfied.

As shown in FIG. 4, a cylindrical cam shaft 38 is provided above the rotary drum 24. The cam shaft 38 is rotatably supported between a pair of support plate 28. Elevation cams 40 are fixed near both ends of the cam shaft 38, respectively. Each elevation cam 40 has a disc shape, and a center of the cam shaft 38 is located right on a center of the elevation cam 40.

The elevation member 42 is provided below the cam shaft 38. Driving frames 44 having a U-shaped cross section are fixed to upper portions of both lateral ends of the elevation member 42, respectively. A disc-like driving board 46 is rotatably supported within each driving frame 44. A tension coil spring 48 is spread between each driving frame 44 and each support plate 28. Each driving frame 44 is urged upward by a urging force of each tension coil spring 48, whereby an upper end of the driving board 46 abuts on a lower end of each elevation cam 40.

Guide plates 50 are fixed to both lateral ends of the elevation member 42, respectively, and a guide groove 52 is formed in each support plate 28. Each guide plate 50 is partially fitted into the guide groove 52. If the cam shaft 38 is rotated and each elevation cam 40 is rotated and moved to a rotation position at which a center of the cam shaft 38 is located just under the center of the elevation cam 40, then the elevation member 42 is distanced from the outer periphery of the rotary drum 24 while the upper end of each driving board 46 abuts on the lower end of each elevation cam 40 by the urging force of each tension coil spring 48. If the cam shaft 38 is rotated in this state, and each elevation cam 40 is rotated and moved (returned) to a rotation position at which the center of the cam shaft 38 is located just on the center of the elevation cam 40, then each driving board 46 is pressed by each elevation cam 40, and each driving frame 44 is lowered against the urging force of each tension coil spring 48. As a result, while each guide plate 50 is guided by each guide groove 52, the elevation member 42 is made closer to the outer periphery of the rotary drum 24.

The predetermined number (eleven in the present embodiment) release pins 54 each of a cylindrical rod shape are fixed to a lower portion of the elevation member 42. A lower end of each release pin 54 is inserted into the press concave portion 36 of each leading end chuck 30 and presses a front side of the leading end chuck 30. Due to this, the nipping portion 35 of each leading end chuck 35 is distanced from the outer periphery of the rotary drum 24 against the urging force of the torsion coil spring 37. Accordingly, the leading end of the printing plate 12 transported from the plate feed guide 20 to the outer periphery of the rotary drum 24 is transported to the portion between the nipping portion 35 of each leading end chuck 30 and the outer periphery of the rotary drum 24.

The printing plate 12 transported to the area between the nipping portion 35 of each leading end chuck 30 and the outer periphery of the rotary drum 24 is positioned such that the leading end of the printing plate 12 abuts on a predetermined number of (two in the embodiment) positioning pins 60 fixed to the outer periphery of the rotary drum 24 between the adjacent leading end chucks 30 (in the embodiment, between fourth and fifth leading end chucks 30 and between seventh and eighth leading end chucks 30 from the right of the rotary drum 24 as shown in FIG. 4), respectively.

After the positioning of the printing plate 12 is finished, the cam shaft 38 is rotated and the elevation member 42 is distanced from the outer periphery of the rotary drum 24. Accordingly, each release pin 54 is away from the press concave portion 36 of each leading end chuck 30, and the pressing of the leading end chuck 30 by the release pin 54 is released. Thus, a predetermined number of nipping portions 35 of the leading end chucks 30 press substantially entirely the leading end of the printing plate 12 by the urging force of the torsion coil springs 37, whereby the leading end of the printing plate 12 is put and held between the outer periphery of the rotary drum 24 and the leading end chucks 30.

Further, the rotary drum 24 is rotated in the arrow A direction shown in FIG. 5, whereby the printing plate 12 is wound around the outer periphery of the rotary drum 24.

As shown in FIG. 5, a cylindrical squeeze roller 55 is provided near the outer periphery of the rotary drum 24 on the arrow A direction-side shown in FIG. 5 relative to the elevation member 42. By moving the squeeze roller 55 toward the rotary drum 24, the printing plate 12 wound around the rotary drum 24 is rotated while being pressed against the rotary drum 24, and the printing plate 12 is fixedly attached onto the outer periphery of the rotary drum 24.

In addition, a rear-end chuck attachment and detachment unit 56 is provided near the outer periphery of the rotary drum 24 on an arrow B direction-side shown in FIG. 5 relative to the elevation member 42. The rear-end chuck attachment and detachment chuck 56 is movable toward the rotary drum 24. A predetermined number of plate-like rear-end chucks 57 are attached to the rear-end chuck attachment and detachment unit 56, and arranged along the lateral direction (i.e., the axial direction of the rotary drum 24).

When the rear end of the printing plate 12 wound around the rotary drum 24 is opposed to the rear-end chuck attachment and detachment unit 56, the rear-end chuck attachment and detachment unit 56 is lowered and the respective rear-end chucks 57 is moved toward the rotary drum 24. The rear-end chucks 57 are thereby attached onto the outer periphery of the rotary drum 24. Thus, by allowing front ends of the predetermined number of rear-end chucks 57 to press substantially entirely the rear end of the printing plate 12 against the outer periphery of the rotary drum 24, the rear end of the printing plate 12 is held on the outer periphery of the rotary drum 24. In addition, simultaneously with attachment of the respective rear-end chucks 57 onto the outer periphery of the rotary drum 24, the respective rear-end chucks 57 are detached from the rear-end chuck attachment and detachment unit 56, and the rear-end chuck attachment and detachment unit 56 is then raised to an origin position (i.e., an initial position).

As can be seen, if the leading end and the rear end of the printing plate 12 are held on the outer periphery of the rotary drum 24 by the leading end chucks 30 and the rear end chucks 57, respectively, the rotary drum 24 is quickly rotated at a predetermined rotational speed after squeeze roller 55 is distanced from the rotary drum 24.

The pressing force F of the nipping portion 35 of each leading end chuck 30 acts on the printing plate 12 held by the nipping portion 35 of the leading end chuck 30 by the high speed rotation of the rotary drum 24. The pressing force F of the nipping portion 35 acts substantially in the same direction as the center axis direction of the rotary drum 24 since the center of the spindle 34 is located at the “pressing position P” on the tangent T of the rotary drum 24 as stated above.

If the rotary drum 24 is rotated at the high speed, an exposure processing for recording an image on the printing plate 12 is carried out. Namely, as shown in FIG. 5, a recording head 58 is arranged near rear of the outer periphery of the rotary drum 24. The recording head 58 emits an optical beam modulated based on read image data to the rotary drum 24 that is rotated at the high speed while being synchronized with the rotation of the rotary drum 24. As a result, the printing plate 12 is exposed based on the image data. This exposure processing is so-called scanning exposure for moving the recording head 58 in the axial direction of the rotary drum 24 (performing a sub-scan) while rotating the rotary drum 24 at the high speed (performing a main scan).

If the exposure processing to the printing plate 12 is finished, then the rotary drum 24 is temporarily stopped at a position at which each rear-end chuck 57 is opposed to the rear-end chuck attachment and detachment unit 56, and the rear-end chuck attachment and detachment unit 56 is lowered toward the rotary drum 24. By doing so, each rear end chuck 57 is detached from the outer periphery of the rotary drum 24, and the holding of the rear end of the printing plate 12 by each rear-end chuck 57 is released. At the same time, each rear-end chuck 57 is attached to the rear-end chuck attachment and detachment unit 56. The rear-end chuck attachment and detachment unit 56 is then raised up to the origin position. Furthermore, after the conveyance guide unit 14 is rotated to make the plate discharge guide 22 correspond to the exposure section 18 (correspond to the tangential direction of the rotary drum 24), the rotary drum 24 is rotated in the arrow B direction shown in FIG. 5. The printing plate 12 is thereby discharged from the leading end side onto the plate discharge guide 22.

At this time, the rotary drum 24 is temporarily stopped at a position at which each release pin 54 is opposed to each leading end chuck 30, the cam shaft 38 is rotated, and the elevation member 42 is made close to the outer periphery of the rotary drum 24 as shown in FIG. 5. As a result, the lower end of each release pin 54 is inserted into the press concave portion 36 of each leading end chuck 30. Therefore, the front end of each leading end chuck 30 is pressed by each release pin 54, the nipping portion 35 of the leading end chuck 30 is distanced from the outer periphery of the rotary drum 24, and the holding of the leading end of the printing plate 12 by the nipping portion 35 of teach leading end chuck 30 is released.

When the printing plate 12 is discharged onto the plate discharge guide 22, the conveyance guide unit 14 is rotated and the printing plate 12 is discharged from the plate discharge guide 22. Consequently, the printing plate 12 is transported to a developer or a printer (not shown) in a next step adjacent to the automatic printing plate exposure apparatus 10.

The function of the embodiment of the invention will next be described.

In the automatic printing plate exposure apparatus 10, if the printing plate 12 is mounted on the plate feed guide 20, the conveyance guide unit 14 is rotated to make the plate feed guide 20 correspond to the punch section 16, thereby transporting the leading end of the printing plate 12 into the punch section 16. The printing plate 12 transported into the punch section 16 is returned onto the plate feed guide 20 after a predetermined number of punch holes are bored through the leading end of the printing plate 12 by the punch section 16.

When the conveyance guide unit 14 is rotated to make the plate feed guide 20 correspond to the exposure section 18, the printing plate 12 is transported to the exposure section 18. The leading end of the printing plate 12 is transported to the portion between the outer periphery of the rotary drum 24 and the nipping portions 35 of the leading end chucks 30, and the leading end of the printing plate 12 abuts on the positioning pins 60, thereby positioning the printing plate 12.

After it is confirmed that the positioning of the leading end of the printing plate 12 is finished, then the elevation member 42 is moved to be away from the rotary drum 24, and the pressing of each leading end chuck 30 by the release pin 54 is released. As a result, the leading end of the printing plate 12 is pressed against the outer periphery of the rotary drum 24 by the nipping portion 35 of each leading end chuck 30 and held thereon.

The rotary drum 24 is rotated in the arrow A direction shown in FIG. 5, and the printing plate 12 is wound around the outer periphery of the rotary drum 24 while being fixedly attached to the outer periphery of the rotary drum 24 by the squeeze roller 55. The rear end of the printing plate 12 is held on the outer periphery of the rotary drum 24 by the rear-end chucks 57.

If the holding of the printing plate 12 on the outer periphery of the rotary drum 24 is finished, the optical beam is applied from the recording head onto the printing plate 12 while the rotary drum 24 is rotated at the high speed, whereby the exposure processing is carried out.

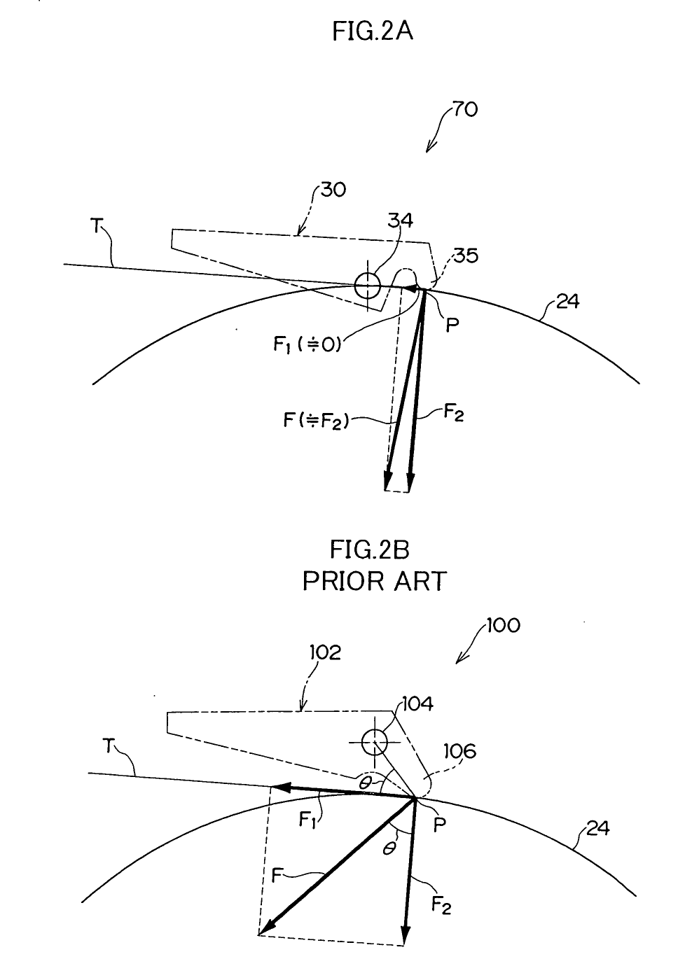

Conventionally, as depicted in a sheet body holding device 100 shown in FIG. 2B, a spindle 104 of each rear-end chuck 102 is arranged, for example, on a side opposite to the rotary drum 24 side relative to the tangent T of the rotary drum at the “pressing position P”, i.e., at a position away from the rotary drum 24. This spindle 104 is arranged at a position at which F1 is higher than (F2×μ), where F denotes a pressing force of the printing plate 12 by the nipping portion 106 of the leading end chuck 102 at the time when the rotary drum 24 is rotated, F1 denotes the component force of the pressing force F in the direction of the tangent T of the rotary drum 24, F2 denotes the component force of the pressing force F in the center axis direction of the rotary drum 24, μ denotes the coefficient of friction between the printing plate 12 and the rotary drum 24, and θ denotes the angle of the line that connects the rotational center of the spindle 104 to the “pressing position P” thereof, with respect to the tangent T of the rotary drum 24 (e.g., the coefficient of friction is set at 0.27, and the angle θ is set at 45°).

Therefore, when the rotary drum 24 is rotated, the force (F1) for moving the printing plate 12 in the circumferential direction of the rotary drum 24 rather than a friction force (F2×μ) between the rear surface of the printing plate 12 and the outer periphery of the rotary drum 24 acts on the leading end of the printing plate 12. Further, an acting direction of the component force F1 corresponds to a direction of pressing the leading end of the printing plate 12 against the positioning pins 60 (not shown in FIG. 2B) (i.e., an arrow direction of F1 shown in FIG. 2B).

Due to this, the leading end of the printing plate 12 is pressed against the positioning pins 60, and the leading end is floated from the rotary drum 24 around the positioning pins 60, thereby disadvantageously causing the focal shift of the image recorded on the printing plate 12.

Moreover, conventionally, the spindle 104 of the tip-leading end chuck 102 is located on the rotary drum 24-side relative to the tangent T of the rotary drum 24 at the “pressing position P”. This spindle 104 is sometimes located at a position at which the component force F1 is higher than (F2×μ). In the latter case, the component force F1 of the pressing force F in the direction of the tangent T of the rotary drum 24 (the force for moving the printing plate 12 in the circumferential direction of the rotary drum 24) acts on the direction of generating slack in the printing plate 12 (i.e., the direction opposite to the direction of the force F1 shown in FIG. 2B). As a result, slack is generated in the printing plate 12 fixedly attached to the rotary drum 24, thereby causing the focal shift of the image recorded on the printing plate 12.

In the sheet body holding device 70 according to the embodiment of the invention, by contrast, the spindle 34 of the leading end chuck 30 is located on the tangent T of the rotary drum 24 at the “pressing position P” at which the printing plate 12 is pressed (i.e., located at the position at which the relationship of F1<(F2×μ) is satisfied).

Therefore, when the rotary drum 24 is rotated at the high speed, the pressing force F of the nipping portion 35 of the leading end chuck 30 acting on the printing plate 12 acts substantially in the same direction as the center axis direction of the rotary drum 24 (i.e., acts thereon substantially in the same direction as the direction of the component force F2 oriented in the center axis direction of the rotary drum 24 with the substantially same magnitude). In other words, the component force F1 of the pressing force F in the direction of the tangent T of the rotary drum 24 (the force for moving the printing plate 12 in the circumferential direction of the rotary drum 24) acts on the printing plate 12 only slightly (i.e., the component force F1 acting thereon is substantially zero). It is, therefore, possible to ensure preventing the printing plate 12 from being moved in the circumferential direction of the rotary drum by the nipping portion 35 of the leading end chuck 30.

Accordingly, during the exposure processing, the movement of the leading end of the printing plate 12 toward the positioning pins 60 is prevented. It is thereby possible to prevent the printing plate 12 from being floated from the rotary drum 24 around the positioning pins 60 after being pressed against the positioning pins 60, and to prevent the focal shift of the image recorded on the printing plate 12.

Further, since the leading end of the printing plate 12 is not moved in the direction in which the printing plate 12 is generated to slack, it is possible to prevent slack to generate in the printing plate 12 fixedly attached onto the rotary drum 24, and to prevent the focal shift of the image recorded on the printing plate 12, thereby ensuring recording a clear image on the printing plate 12.

Moreover, since the leading end of the printing plate 12 is not moved in the circumferential direction of the rotary drum 24, it is possible to prevent the deviation of the position of the image to be recorded from the reference position of each punch hole or the like bored through the leading end of the printing plate 12 in advance.

When the exposure processing to the printing plate 12 by the recording head 58 is finished, each rear-end chuck 57 is detached from the outer periphery of the rotary drum 24 by the rear-end chuck attachment and detachment unit 56, thereby discharging the printing plate 12 onto the plate discharge guide 22 from the rear end side.

At this time, the rotary drum 24 is temporarily stopped at the position at which each release pin 54 is opposed to each leading end chuck 30, and the holding of the leading end of the printing plate 12 by the nipping portion 35 of each leading end chuck 30 is released by each release pin 54.

When the printing plate 12 is discharged onto the plate discharge guide 22, the conveyance guide unit 14 is rotated and the printing plate 12 is discharged from the plate discharge guide 22. Consequently, the printing plate 12 is transported to the developer or the printer (not shown) in the next step adjacent to the automatic printing plate exposure apparatus 10.

The sheet body holding device 70 constituted as stated above can prevent the printing plate 12 from being moved in the circumferential direction of the rotary drum 24. It is thereby possible to prevent the printing plate 12 from being floated from the outer periphery of rotary drum 24 due to the movement of the printing plate 12 in the circumferential direction of the rotary drum 24.

The structure of the device, as shown in the sheet body holding device 70 according to the embodiment, in which the spindle 34 is located on the tangent T of the rotary drum 24 at the “pressing position P” is particularly advantageous for a mechanism in which the leading end chuck 30 is rotated slightly by the centrifugal force during the rotation of the rotary drum 24 by forming the nipping portion 35 of the leading end chuck 30 into a crown shape or the like.

As stated so far, the sheet body holding device according to the embodiment of the invention can prevent the sheet body being moved in the circumferential direction of the rotary from drum. In addition, the sheet body holding device can prevent the sheet body from being floated from the outer periphery of rotary drum.

What is claimed is:

1. A sheet body holding device for holding a sheet body on an outer periphery of a rotary drum, comprising:
a spindle that rotatably supports the sheet body holding device on the outer periphery of the rotary drum, around which the sheet body is wound; and
one end urged toward the rotary drum, and pressing an end of the sheet body against the outer periphery of the rotary drum, thereby holding the end of the sheet body on the outer periphery of the rotary drum, wherein
the spindle is arranged at a position at which a relationship of F1<(F2×μ) is satisfied, where F1 is a component force, in a tangential direction of the rotary drum, of a pressing force of the one end for pressing the sheet body during rotation of the rotary drum, F2 is a component force of the pressing force in a direction of a center axis of the rotary drum, and μ is a coefficient of friction between the sheet body and the outer periphery of the rotary drum.

2. A sheet body holding device according to claim 1, wherein
a center of the spindle is located on a tangent of the rotary drum intersecting a pressing position at which the sheet body is pressed against the rotary drum.

3. A sheet body holding device according to claim 1, wherein
a plurality of the sheet body holding devices are arranged on the rotary drum.

4. A sheet body holding device according to claim 1, wherein
an angle θ formed between a line that connects a center of the spindle and the pressing position at which the sheet body is pressed against the rotary drum and the tangent of the rotary drum intersecting the pressing position is acute.

5. A sheet body holding device according to claim 4, wherein
the center of the spindle is arranged on a side of the outer periphery of the rotary drum relative to the tangent of the rotary drum intersecting the pressing position.

6. A sheet body holding device according to claim 4, wherein
the spindle is arranged at a position away from the outer periphery of the rotary drum relative to a tangent of the rotary drum.

7. A sheet body holding device according to claim 4, wherein
the spindle is arranged at a position at which the angle θ is in the range of −15°<θ<15°.

8. A sheet body holding device for holding a sheet body on an outer periphery of a rotary drum, comprising:
a spindle that rotatably supports the sheet body holding device on the outer periphery of the rotary drum, around which the sheet body is wound; and
one end urged toward the rotary drum, and pressing an end of the sheet body against the outer periphery of the rotary drum, thereby holding the end of the sheet body on the outer periphery of the rotary drum, wherein
an angle θ is formed between a line that connects a pressing position at which the one end presses the sheet body against the rotary drum and a center of the spindle and a tangent of the rotary drum intersecting the pressing position, and the spindle is located at a position at which the angle θ is acute.

9. A sheet body holding device according to claim 8, wherein
the center of the spindle is located on the tangent of the rotary drum intersecting the pressing position.

10. A sheet body holding device according to claim 8, wherein
the center of the spindle is arranged on a side of the outer periphery of the rotary drum relative to the tangent of the rotary drum intersecting the pressing position.

11. A sheet body holding device according to claim 8, wherein
the center of the spindle is arranged at a position away from the outer periphery of the rotary drum relative to the tangent of the rotary drum intersecting the pressing position.

12. A sheet body holding device according to claim 8, wherein
the center of the spindle is arranged at a position at which the angle θ is in the range of −15°<θ<15°.

13. A sheet body holding device according to claim 8, wherein
a plurality of the sheet body holding devices are arranged on the rotary drum.

14. A sheet body holding device according to claim 8, wherein
the spindle is arranged at a position at which a relationship of F1<(F2×μ) is satisfied, where F1 is a component force, in a tangential direction of the rotary drum, of a pressing force of the one end for pressing the sheet body during rotation of the rotary drum, F2 is a component force of the pressing force in a direction of a center axis of the rotary drum, and μ is a coefficient of friction between the sheet body and the outer periphery of the rotary drum.

15. A method for manufacturing a sheet body holding device that holds a sheet body on an outer periphery of a rotary drum, comprising:
forming a spindle that rotatably supports the sheet body holding device on the outer periphery of the rotary drum, around which the sheet body is wound; and
forming one end which is urged toward the rotary drum and presses an end of the sheet body against the outer periphery of the rotary drum, thereby holding the end of the sheet body on the outer periphery of the rotary drum, wherein
an angle θ is formed between a line that connects a pressing position at which the one end presses the sheet body against the rotary drum and a center of the spindle and a tangent of the rotary drum intersecting the pressing position, and the spindle is located at a position at which the angle θ is acute.

16. A method according to claim 15, wherein
the center of the spindle is located on the tangent of the rotary drum intersecting the pressing position.

17. A method according to claim 15, wherein
the spindle is arranged at a position at which the angle θ is in the range of −15°<<15°.

18. A method according to claim 15, wherein
the spindle is arranged at a position at which a relationship of F1<(F2×μ) is satisfied, where F1 is a component force, in a tangential direction of the rotary drum, of a pressing force of the one end for pressing the sheet body during rotation of the rotary drum, F2 is a component force of the pressing force in a direction of a center axis of the rotary drum, and μ is a coefficient of friction between the sheet body and the outer periphery of the rotary drum.

19. A printing plate exposure apparatus comprising a sheet body holding device including:
a spindle rotatably supporting the sheet body holding device on an outer periphery of a rotary drum around which the sheet body is wound; and
one end urged toward the rotary drum, and pressing an end of the sheet body against the outer periphery of the rotary drum, thereby holding the end of the sheet body on the outer periphery of the rotary drum, wherein
an angle θ is formed between a line that connects a pressing position at which the one end presses the sheet body against the rotary drum and a center of the spindle and a tangent of the rotary drum intersecting the pressing position, and the spindle is located at a position at which the angle θ is acute.
